(19) United States
(12) Patent Application Publication
(10) Pub. No.: US 2014/0232672 A1
(43) Pub. Date: Aug. 21, 2014

(54) METHOD AND TERMINAL FOR TRIGGERING APPLICATION PROGRAMS AND APPLICATION PROGRAM FUNCTIONS

(71) Applicant: TENCENT TECHNOLOGY (SHENZHEN) COMPANY LIMITED, Shenzhen (CN)

(72) Inventor: YUNLONG ZHANG, Shenzhen (CN)

(73) Assignee: TENCENT TECHNOLOGY (SHENZHEN) COMPANY LIMITED, Shenzhen (CN)

(21) Appl. No.: 14/249,672

(22) Filed: Apr. 10, 2014

Related U.S. Application Data
(63) Continuation of application No. PCT/CN2014/071471, filed on Jan. 26, 2014.

(30) Foreign Application Priority Data
Feb. 20, 2013 (CN) 2013100546143

(51) Int. Cl. G06F 3/041

(52) U.S. Cl. CPC G06F 3/041
USPC 345/173

(57) ABSTRACT

A touch-based triggering method is provided for a mobile terminal. The method includes receiving a plurality of touch trajectories and, based on application programs or application program functions to be configured, establishing a mapping index table for storing mapping relationships between the received touch trajectories and the application programs or application program functions. The method also includes storing the mapping index table on the mobile terminal. Further, the method includes detecting and responding to a touch event, obtaining a touch trajectory corresponding to the touch event, comparing the obtained touch trajectory with the touch trajectories stored in the mapping index table for similarity matching and, when the obtained touch trajectory matches a stored touch trajectory in the mapping index table, triggering the application program or application program function corresponding to the stored touch trajectory.

### CROSS-REFERENCES TO RELATED APPLICATIONS

This application is a continuation application of PCT Patent Application No. PCT/CN2014/071471, filed on Jan. 26, 2014, which claims priority of Chinese Patent Application No. 201310054614.3, filed on Feb. 20, 2013, the entire contents of both of which are incorporated by reference herein.

### FIELD OF THE INVENTION

The present invention generally relates to touch-screen based computer technologies and, more particularly, to a method and system for triggering application program functionalities based on touch.

### BACKGROUND

For most commonly used touch terminals, a specific application or functions of a specific application on a touch terminal often can only be triggered by a pre-set trigger mode (such as function keys). Such triggering method often fails to effectively use the touch control functions of the touch terminal. Further, the pre-set trigger mode is relatively rigid and, for those users with special operating habits or preferences, the operation under this mode is relatively stiff and error prone. In addition, with respect to mobile terminals, due to the limited screen size of a mobile terminal, commonly used function keys of some applications cannot be fully displayed on the user interface, greatly limiting the terminal's operation.

The disclosed method and system are directed to solve one or more problems set forth above and other problems.

### BRIEF SUMMARY OF THE DISCLOSURE

One aspect of the present disclosure includes a touch-based triggering method for a mobile terminal. The method includes receiving a plurality of touch trajectories and, based on application programs or application program functions to be configured, establishing a mapping index table for storing mapping relationships between the received touch trajectories and the application programs or application program functions. The method also includes storing the mapping index table on the mobile terminal. Further, the method includes detecting and responding to a touch event, obtaining a touch trajectory corresponding to the touch event, comparing the obtained touch trajectory with the touch trajectories stored in the mapping index table for similarity matching and, when the obtained touch trajectory matches a stored touch trajectory in the mapping index table, triggering the application program or application program function corresponding to the stored touch trajectory.

Another aspect of the present disclosure includes a mobile terminal with touch-based triggering functionality. The mobile terminal includes a parameter setting module, a trajectory acquisition module, and a function trigger module. The parameter setting module is configured to receive a plurality of touch trajectories and, based on application programs or application program functions to be configured, to establish a mapping index table for storing mapping relationships between the received touch trajectories and the application programs or application program functions. The parameter setting module is further configured to store the mapping index table on the mobile terminal. The trajectory acquisition module is configured to detect and respond to a touch event, and to obtain a touch trajectory corresponding to the touch event. Further, the function trigger module is configured to compare the obtained touch trajectory with the touch trajectories stored in the mapping index table for similarity matching and, when the obtained touch trajectory matches a stored touch trajectory in the mapping index table, to trigger the application program or application program function corresponding to the stored touch trajectory.

Another aspect of the present disclosure includes a non-transitory computer-readable medium having computer program. When being executed by a processor, the computer program performs a touch-based triggering method for a mobile terminal. The method includes receiving a plurality of touch trajectories and, based on application programs or application program functions to be configured, establishing a mapping index table for storing mapping relationships between the received touch trajectories and the application programs or application program functions. The method also includes storing the mapping index table on the mobile terminal. Further, the method includes detecting and responding to a touch event, obtaining a touch trajectory corresponding to the touch event, comparing the obtained touch trajectory with the touch trajectories stored in the mapping index table for similarity matching and, when the obtained touch trajectory matches a stored touch trajectory in the mapping index table, triggering the application program or application program function corresponding to the stored touch trajectory.

Other aspects of the present disclosure can be understood by those skilled in the art in light of the description, the claims, and the drawings of the present disclosure.

### BRIEF DESCRIPTION OF THE DRAWINGS

FIG. 1 illustrates a flow diagram of an exemplary application program or application program function triggering process consistent with the disclosed embodiments;

FIG. 2 illustrates an exemplary application program using the gesture or touch trajectory to trigger application program functions consistent with the disclosed embodiments;

FIG. 3 illustrates a functional block diagram of an exemplary mobile terminal using gesture or touch trajectory for triggering application programs or application program functions consistent with the disclosed embodiments; and

FIG. 4 illustrates a block diagram of an exemplary mobile terminal consistent with the disclosed embodiments.

### DETAILED DESCRIPTION

Reference will now be made in detail to exemplary embodiments of the invention, which are illustrated in the accompanying drawings.

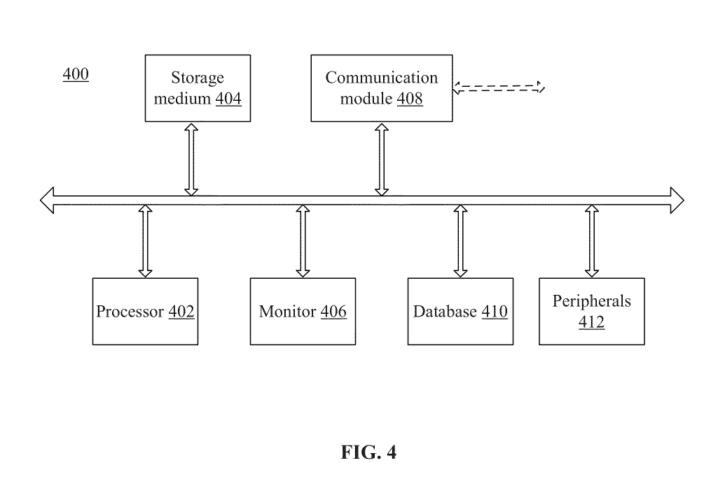

FIG. 4 illustrates an exemplary mobile terminal 400 for implementing the disclosed methods and terminal. A mobile terminal may include any appropriate type of mobile computing devices, such as mobile phones, smart phones, tablets, notebook computers, or any type of mobile computing platform. A mobile terminal may be controlled by an operating system and may support various application software to provide certain application programs and application program functions. For example, the application program may include a browser, a calendar application, a drawing application, a child learning application, or any appropriate user application, etc.

As shown in FIG. 4, mobile terminal 400 may include a processor 402, a storage medium 404, a monitor 406, a communication module 408, a database 410, and peripherals 412. Certain devices may be omitted and other devices may be included.

Processor 402 may include any appropriate processor or processors. Further, processor 402 can include multiple cores for multi-thread or parallel processing. Storage medium 404 may include memory modules, such as Read-only memory (ROM), Random Access Memory (RAM), flash memory modules, and erasable and rewritable memory, and mass storages, such as CD-ROM, U-disk, and hard disk, etc. Storage medium 404 may store computer programs for implementing various processes, when executed by processor 402.

Further, peripherals 412 may include I/O devices, such as keyboard, mouse, camera, video camera, and/or sensors, etc. Monitor 406 may include any appropriate screen for displaying various information to a user. For example, monitor 406 may be a touch screen providing displaying functions as well as input functions.

The communication module 408 may include network devices for establishing connections through a communication network, such as a wireless network or a wired network. Database 410 may include one or more databases for storing certain data and for performing certain operations on the stored data, such as database searching.

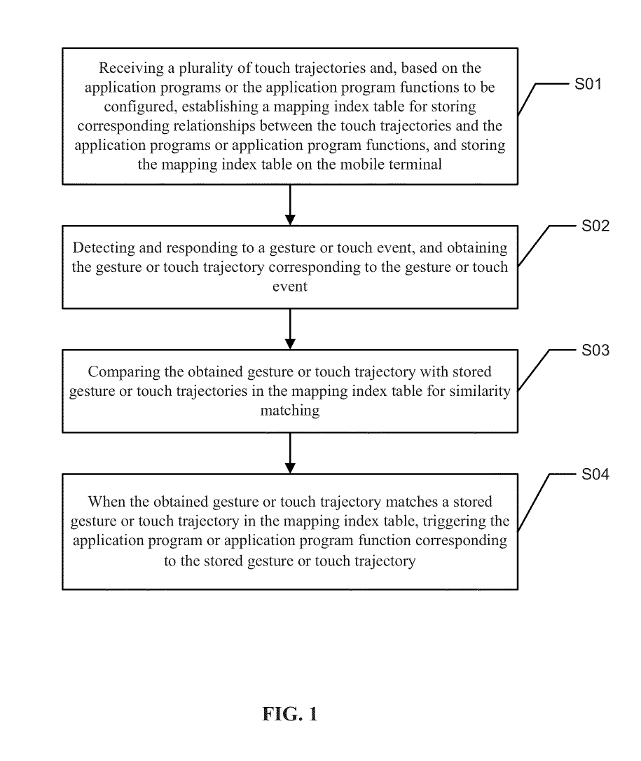

In operation, the mobile terminal 400 may provide certain application programs and/or application program functions to a user of the mobile terminal 400. The user may trigger the application program functionalities via a touch screen. FIG. 1 illustrates a flow diagram of an exemplary application program or application program function triggering process consistent with the disclosed embodiments.

As shown in FIG. 1, the touch-based triggering process may include the following steps.

Step S01, establishing a mapping index table containing mapping relationships between specific gesture or touch trajectories inputted by a user on a touch screen of the mobile terminal and corresponding application programs or application program functions. A gesture or touch trajectory may refer to position and track information of screen touch by the user (e.g., finger touch) including information on touch direction, touch pattern, touch surface, number of touch points, etc.

That is, the user inputs a plurality of touch trajectories and, based on the application programs or the application program functions to be set up, a mapping index table is created for storing corresponding relationships between the touch trajectories and the application programs or application program functions. The mapping index table is also stored on the mobile terminal.

The application programs or the application program functions are those application programs or application program functions that can be triggered by a gesture or touch by the user. For example, the different user gestures or touches may be used to trigger opening a browser, opening a WeChat, closing space, or to trigger different functions of drawing software program such as the rendering function, coloring function, and animation function of BabyPaint (i.e., an interactive drawings application program).

In one embodiment, details of the process used by the terminal to establish the mapping index table between gesture or touch trajectories inputted by the user and corresponding application programs or application program functions are as follows:

The terminal detects in real-time whether a mapping index configuration command is triggered. When the terminal detects that the mapping index command is triggered, the terminal responds to the mapping index configuration command, and determine an application program or application program function to be set, as selected by the user. Further, after the user inputs a specific gesture or touch trajectory corresponding to the selected application program or application program function, the terminal obtains the inputted specific gesture or touch trajectory, and establish a mapping relationship between the specific gesture or touch trajectory and the selected application program or application program function. Further, the terminal also stores the mapping relationship in the mapping index table.

The terminal may establish the mapping relationship between the specific gesture or touch trajectory and the selected application program or application program function in different ways. For example, based on inputted gestures or touch trajectories, the terminal may establish the mapping relationship between the gesture or touch trajectory and the selected application program or application program function one-by-one.

Alternatively, the terminal may first sort the selected application programs or application program functions to be configured based on preset rules (e.g., based on the usage frequency of the selected application programs or application program functions). The inputted gestures or touch trajectories are also sorted based on time of entering by the user. The sorted gestures or touch trajectories and the sorted application programs or application program functions can then be mapped into a one-to-one relationship sequentially. Thus, the mapping relationships between the inputted gestures or touch trajectories and the application programs or application program functions can be established.

Step S02, detecting and responding to a gesture or touch event, and obtaining the gesture or touch trajectory corresponding to the gesture or touch event. That is, the terminal detects in real-time whether any gesture or touch event is triggered. When the terminal detects that a gesture or touch event is triggered, the terminal responds to the gesture or touch event and further obtains the gesture or touch trajectory corresponding to the gesture or touch event.

The terminal can also detects the gesture or touch event periodically. For example, the terminal may detect the gesture or touch event every 0.05 ms. Any appropriate time period may be used.

Step S03, comparing the obtained gesture or touch trajectory with stored gesture or touch trajectories in the mapping index table for similarity matching.

Step S04, when the obtained gesture or touch trajectory matches a stored gesture or touch trajectory in the mapping index table, the terminal triggers the application program or application program function corresponding to the stored gesture or touch trajectory.

Specifically, the terminal may perform the similarity matching between the obtained gesture or touch trajectory with stored gesture or touch trajectories in the mapping index table as follows:

The terminal scales the obtained gesture or touch trajectory into same size as the stored gesture or touch trajectories and normalizes the obtained gesture or touch trajectory into same coordinate system as the stored gesture or touch trajectories. Further, the terminal determines whether the similarity between the scaled and normalized gesture or touch trajectory and any stored gesture or touch trajectory is greater than a preset threshold. If the similarity is greater than the preset threshold, the match between the scaled and normalized gesture or touch trajectory and the stored gesture or touch trajectory is successful. Otherwise, the match is not successful.

In one embodiment, the similarity matching between the obtained gesture or touch trajectory with stored gesture or touch trajectories in the mapping index table can also include the follows.

The terminal may use characteristic values of the obtained gesture or touch trajectory and the stored gesture or touch trajectories to compose row vectors, and generates a covariance matrix of the characteristic row vectors based on the composed row vectors. Further, the terminal may use a one-dimensional development plan (DP) matching method on the row vectors in the covariance equation of the obtained gesture or touch trajectory and the stored gesture or touch trajectories, and generates a similar row vector as a substitute of the covariance matrix of the obtained gesture or touch trajectory. Based on the one-dimensional DP matching, the matching distance between the similar row vector and the standard row vector of the covariance matrix of the obtained gesture or touch trajectory, and similarity between the obtained gesture or touch trajectory and the stored gesture or touch trajectories can be obtained. In addition, a direction entropy method can also be used to obtain the similarity between the obtained gesture or touch trajectory and the stored gesture or touch trajectories.

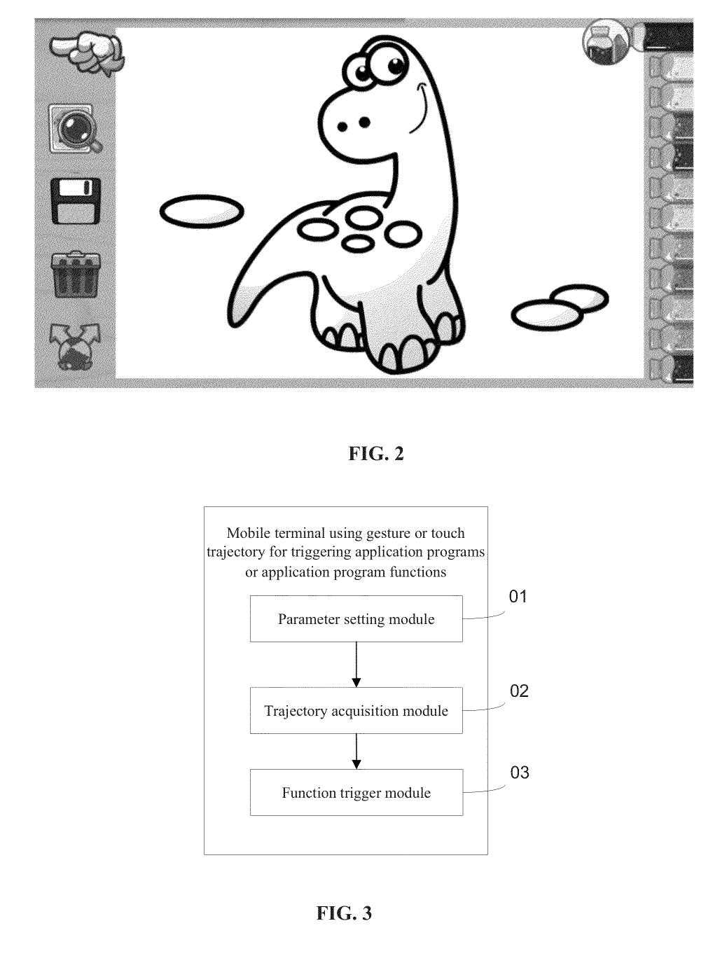

FIG. 2 illustrates an exemplary application program using the gesture or touch trajectory to trigger application program and/or application program functions. Specifically, the application program is a drawing application program called BabyPaint, which is provided on a mobile terminal and has a plurality of functions that can be triggered by user's gesture or touch trajectory.

As shown in FIG. 2, on a touch screen of the mobile terminal, the user interface of BabyPaint includes a plurality of function keys. For example, on the left side of the interface, from top down, the function keys include “Return”, “View Original Image”, “Save”, “Delete”, and “Share.” The small button on the right corner is a toggle button for coloring effect function, and the remaining buttons on the right side are coloring buttons. However, when new functional keys are to be added to the interface, the space on the interface may be insufficient for adding new function keys. Touch-trajectory-based function trigger or function keys may then be added to the interface.

A painting or coloring application program in general may include a plurality layer of images. For example, BabyPaint may include four layers of images. The first layer is an animation layer, which contains animated images to be displayed at specific time periods to realize the effects of animation. The second layer is an edge texture layer, which contains images presented to the user for coloring, i.e., the image to be colored or painted.

The third layer is a coloring layer, which is a separate layer designed for coloring or painting so as to prevent the color of other layers from being messed up during coloring or painting. At the beginning, this layer is a blank layer. The fourth layer is a bottom edge layer, which contains wireframe image used for by the coloring layer to determine the boundary of the coloring. Other layers may also be used.

The four layers are overlapped together sequentially, with the animation layer at the top. During a coloring operation, the coloring function is to monitor the screen touch point. When the touch point is in the image to be colored, the coloring layer gets the event, obtains the current color value, and cover an area containing the touch point with the current color value.

Further, before the user starts coloring images in the program, the user may set up function triggering using gesture or touch trajectories. As explained above, the user can set a mapping index table with mapping relationship between gesture or touch trajectories and functions of BabyPaint. For example, the user may set up the mapping relationship shown in Table 1.

TABLE 1

| Gesture and Action | Function |
|---|---|
| Single finger click | Brush paint effect |
| Two finger click | Sand paint effect |
| Three finger click | Snow flower effect |
| Single finger straight line slide | Cancel previous coloring |
| Two finger straight line slide | . . . |
| Three finger straight line slide | . . . |

As shown in Table 1, a single finger click trajectory is mapped to brush paint effect function, a two finger click trajectory is mapped to sand paint effect, a three finger click trajectory is mapped to snow flower effect function, and a single finger straight line slide trajectory is mapped to cancel the previous coloring function, etc. Other functions can also be mapped to different gesture or touch trajectories, such as two finger straight line slide, three finger straight line slide, etc.

Further, during operation, when the terminal detects a gesture or touch event, the terminal respond to the touch event and obtains the gesture or touch trajectory. Further, the terminal matches the obtained gesture or touch trajectory with the gesture or touch trajectories stored in the mapping index table. If the matching is successfully, the terminal triggers the function corresponding to the stored gesture or touch trajectory matching the obtained gesture or touch trajectory.

For example, if the obtained gesture or touch trajectory matches the stored gesture or touch trajectory for “two finger click,” the function corresponding to the “two finger click” is triggered, and the touch event as well as touch trajectory information is passed to the coloring layer, which renders the painted image with sand paint effect. Other functions may also be triggered similarly.

FIG. 3 illustrates a functional block diagram of an exemplary mobile terminal using gesture or touch trajectory for triggering application programs or application program functions.

As shown in FIG. 3, the terminal having the touch triggering capability may includes a parameter setting module 01, a trajectory acquisition module 02, and a function trigger module 03. Other modules may also be included.

The parameter setting module 01 is configured to establish a mapping index table containing mapping relationships between specific gesture or touch trajectories inputted by a user on a touch screen of the mobile terminal and corresponding application programs or application program functions.

That is, the parameter setting module 01 is configured to receive a plurality of touch trajectories inputted by the user and, based on the application programs or the application program functions to be set up, to establish a mapping index table is created for storing corresponding relationships between the touch trajectories and the application programs or application program functions. The parameter setting module 01 also stores the mapping index table on the mobile terminal.

The application programs or the application program functions are those application programs or application program functions that can be triggered by a gesture or touch by the user. For example, the different user gestures or touches may be used to trigger opening a browser, opening a WeChat, closing space, or to trigger different functions of drawing software program such as the rendering function, coloring function, and animation function of BabyPaint (i.e., an interactive drawings application program).

In one embodiment, parameter setting module 01 may be configured to establish the mapping index table between gesture or touch trajectories inputted by the user and corresponding application programs or application program functions as follows:

The parameter setting module 01 detects in real-time whether a mapping index configuration command is triggered. When the parameter setting module 01 detects that the mapping index command is triggered, the parameter setting module 01 responds to the mapping index configuration command, and determine an application program or application program function to be set, as selected by the user. Further, after the user inputs a specific gesture or touch trajectory corresponding to the selected application program or application program function, the parameter setting module 01 obtains the inputted specific gesture or touch trajectory, and establishes a mapping relationship between the specific gesture or touch trajectory and the selected application program or application program function. Further, the parameter setting module 01 also stores the mapping relationship in the mapping index table.

The parameter setting module 01 may establish the mapping relationship between the specific gesture or touch trajectory and the selected application program or application program function in different ways. For example, based on inputted gestures or touch trajectories, the parameter setting module 01 may establish the mapping relationship between the gesture or touch trajectory and the selected application program or application program function one-by-one.

Alternatively, the parameter setting module 01 may first sort the selected application programs or application program functions to be configured based on preset rules (e.g., based on the usage frequency of the selected application programs or application program functions). The inputted gestures or touch trajectories are also sorted based on time of entering by the user. The sorted gestures or touch trajectories and the sorted application programs or application program functions can then be mapped into a one-to-one relationship sequentially. Thus, the mapping relationships between the inputted gestures or touch trajectories and the application programs or application program functions can be established.

The trajectory acquisition module 02 is configured to detect and respond to a gesture or touch event, and to obtain the gesture or touch trajectory corresponding to the gesture or touch event. That is, the trajectory acquisition module 02 detects in real-time whether any gesture or touch event is triggered. When the trajectory acquisition module 02 detects that a gesture or touch event is triggered, the trajectory acquisition module 02 responds to the gesture or touch event and further obtains the gesture or touch trajectory corresponding to the gesture or touch event.

The trajectory acquisition module 02 can also detects the gesture or touch event periodically. For example, the trajectory acquisition module 02 may detect the gesture or touch event every 0.05 ms. Any appropriate time period may be used.

The function trigger module 03 is configured to compare the obtained gesture or touch trajectory with stored gesture or touch trajectories in the mapping index table for similarity matching and, when the obtained gesture or touch trajectory matches a stored gesture or touch trajectory in the mapping index table, to trigger the application program or application program function corresponding to the stored gesture or touch trajectory.

Specifically, the function trigger module 03 may perform the similarity matching between the obtained gesture or touch trajectory with stored gesture or touch trajectories in the mapping index table as follows:

The function trigger module 03 scales the obtained gesture or touch trajectory into same size as the stored gesture or touch trajectories and normalizes the obtained gesture or touch trajectory into same coordinate system as the stored gesture or touch trajectories. Further, the function trigger module 03 determines whether the similarity between the scaled and normalized gesture or touch trajectory and any stored gesture or touch trajectory is greater than a preset threshold. If the similarity is greater than the preset threshold, the match between the scaled and normalized gesture or touch trajectory and the stored gesture or touch trajectory is successful. Otherwise, the match is not successful.

In one embodiment, the similarity matching between the obtained gesture or touch trajectory with stored gesture or touch trajectories in the mapping index table can also include the follows.

The function trigger module 03 may use characteristic values of the obtained gesture or touch trajectory and the stored gesture or touch trajectories to compose row vectors, and generates a covariance matrix of the characteristic row vectors based on the composed row vectors. Further, the function trigger module 03 may use a one-dimensional development plan (DP) matching method on the row vectors in the covariance equation of the obtained gesture or touch trajectory and the stored gesture or touch trajectories, and generates a similar row vector as a substitute of the covariance matrix of the obtained gesture or touch trajectory. Based on the one-dimensional DP matching, the matching distance between the similar row vector and the standard row vector of the covariance matrix of the obtained gesture or touch trajectory, and similarity between the obtained gesture or touch trajectory and the stored gesture or touch trajectories can be obtained. In addition, the function trigger module 03 may also use a direction entropy method to obtain the similarity between the obtained gesture or touch trajectory and the stored gesture or touch trajectories

Therefore, methods and terminals can be provided for receiving a plurality of touch trajectories and, based on the application programs or the application program functions to be configured, establishing a mapping index table for storing corresponding relationships between the touch trajectories and the application programs or application program functions, and storing the mapping index table on the mobile terminal. Further, the methods and terminals are used for detecting and responding to a gesture or touch event, and obtaining the gesture or touch trajectory corresponding to the gesture or touch event; comparing the obtained gesture or touch trajectory with stored gesture or touch trajectories in the mapping index table for similarity matching; and, when the obtained gesture or touch trajectory matches a stored gesture or touch trajectory in the mapping index table, triggering the application program or application program function corresponding to the stored gesture or touch trajectory.

Those skilled in the art should understand that all or part of the above methods and terminals may be executed by relevant hardware instructed by computer program, and the computer program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and terminals, a plurality of touch trajectories can be received and, based on the application programs or the application program functions to be configured, a mapping index table for storing corresponding relationships between the touch trajectories and the application programs or application program functions can be established, and the mapping index table can be stored on the mobile terminal. Further, a gesture or touch event can be detected and responded to, and the gesture or touch trajectory corresponding to the gesture or touch event can be obtained. Further, the obtained gesture or touch trajectory with stored gesture or touch trajectories in the mapping index table can be compared for similarity matching; and, when the obtained gesture or touch trajectory matches a stored gesture or touch trajectory in the mapping index table, the application program or application program function corresponding to the stored gesture or touch trajectory can be triggered. Thus, the user can trigger the application programs and/or application program functions by self-defined gestures or touch trajectories, enriching the functionalities of the mobile terminal and improving the intelligence of the mobile terminal.

What is claimed is:

1. A touch-based triggering method for a mobile terminal, comprising:
receiving a plurality of touch trajectories;
based on application programs or application program functions to be configured, establishing a mapping index table for storing mapping relationships between the received touch trajectories and the application programs or application program functions;
storing the mapping index table on the mobile terminal;
detecting and responding to a touch event;
obtaining a touch trajectory corresponding to the touch event;
comparing the obtained touch trajectory with the touch trajectories stored in the mapping index table for similarity matching; and
when the obtained touch trajectory matches a stored touch trajectory in the mapping index table, triggering the application program or application program function corresponding to the stored touch trajectory.

2. The method according to claim 1, wherein establishing the mapping index table further includes:
detecting and responding to a mapping index configuration command;
determining an application program or application program function to be configured based on the configuration command;
receiving an inputted specific touch trajectory;
establishing a mapping relationship between the specific touch trajectory and the determined application program or application program function; and
storing the mapping relationship in the mapping index table.

3. The method according to claim 1, wherein comparing the obtained touch trajectory with the touch trajectories stored in the mapping index table for similarity matching further includes:
scaling the obtained touch trajectory into a same size as the stored touch trajectories and normalizing the obtained touch trajectory into a same coordinate system as the stored touch trajectories;
determining whether a similarity between the scaled and normalized touch trajectory and any stored touch trajectory is greater than a preset threshold; and
when the similarity is greater than the preset threshold, determining that the match between the obtained touch trajectory and the stored touch trajectory is successful.

4. The method according to claim 2, wherein the application programs or the application program functions are those application programs or application program functions that can be triggered by a touch trajectory.

5. The method according to claim 1, wherein:
the application programs include a painting program; and
the obtained touch trajectories includes one or more of a single finger click trajectory, a two finger click trajectory, a three finger click trajectory, a single finger straight line slide trajectory, a two finger straight line slide trajectory, and a three finger straight line slide trajectory.

6. The method according to claim 5, wherein the mapping relationships in the mapping index table include:
the single finger click trajectory is mapped to a first paint effect function;
the two finger click trajectory is mapped to a second paint effect function; and
the three finger click trajectory is mapped to a third paint effect function.

7. The method according to claim 6, wherein the mapping relationships in the mapping index table further include:
the single finger straight line slide trajectory is mapped to a function canceling a previous coloring function.

8. A mobile terminal with touch-based triggering functionality, comprising:
a parameter setting module configured to:
receive a plurality of touch trajectories;
based on application programs or application program functions to be configured, establish a mapping index table for storing mapping relationships between the received touch trajectories and the application programs or application program functions; and
store the mapping index table on the mobile terminal;
a trajectory acquisition module configured to:
detect and respond to a touch event; and
obtain a touch trajectory corresponding to the touch event; and
a function trigger module configured to
compare the obtained touch trajectory with the touch trajectories stored in the mapping index table for similarity matching; and
when the obtained touch trajectory matches a stored touch trajectory in the mapping index table, trigger the application program or application program function corresponding to the stored touch trajectory.

9. The mobile terminal according to claim 8, wherein the parameter setting module is further configured to:
detect and respond to a mapping index configuration command;
determine an application program or application program function to be configured based on the configuration command;
receive an inputted specific touch trajectory;
establish a mapping relationship between the specific touch trajectory and the determined application program or application program function; and
store the mapping relationship in the mapping index table.

10. The mobile terminal according to claim 8, wherein the function trigger module is further configured to:
scale the obtained touch trajectory into a same size as the stored touch trajectories and normalizing the obtained touch trajectory into a same coordinate system as the stored touch trajectories;
determine whether a similarity between the scaled and normalized touch trajectory and any stored touch trajectory is greater than a preset threshold; and
when the similarity is greater than the preset threshold, determine that the match between the obtained touch trajectory and the stored touch trajectory is successful.

11. The mobile terminal according to claim 9, wherein the application programs or the application program functions are those application programs or application program functions that can be triggered by a touch trajectory.

12. The mobile terminal according to claim 8, wherein:
the application programs include a painting program; and
the obtained touch trajectories includes one or more of a single finger click trajectory, a two finger click trajectory, a three finger click trajectory, a single finger straight line slide trajectory, a two finger straight line slide trajectory, and a three finger straight line slide trajectory.

13. The mobile terminal according to claim 12, wherein the mapping relationships in the mapping index table include:
the single finger click trajectory is mapped to a first paint effect function;
the two finger click trajectory is mapped to a second paint effect function; and
the three finger click trajectory is mapped to a third paint effect function.

14. The mobile terminal according to claim 13, wherein the mapping relationships in the mapping index table further include:
the single finger straight line slide trajectory is mapped to a function canceling a previous coloring function.

15. A non-transitory computer-readable medium having computer program for, when being executed by a processor, performing a touch-based triggering method for a mobile terminal, the method comprising:
receiving a plurality of touch trajectories;
based on application programs or application program functions to be configured, establishing a mapping index table for storing mapping relationships between the received touch trajectories and the application programs or application program functions;
storing the mapping index table on the mobile terminal;
detecting and responding to a touch event;
obtaining a touch trajectory corresponding to the touch event;
comparing the obtained touch trajectory with the touch trajectories stored in the mapping index table for similarity matching; and
when the obtained touch trajectory matches a stored touch trajectory in the mapping index table, triggering the application program or application program function corresponding to the stored touch trajectory.

16. The non-transitory computer-readable medium according to claim 15, wherein establishing the mapping index table further includes:
detecting and responding to a mapping index configuration command;
determining an application program or application program function to be configured based on the configuration command;
receiving an inputted specific touch trajectory;
establishing a mapping relationship between the specific touch trajectory and the determined application program or application program function; and
storing the mapping relationship in the mapping index table.

17. The non-transitory computer-readable medium according to claim 15, wherein comparing the obtained touch trajectory with the touch trajectories stored in the mapping index table for similarity matching further includes:
scaling the obtained touch trajectory into a same size as the stored touch trajectories and normalizing the obtained touch trajectory into a same coordinate system as the stored touch trajectories;
determining whether a similarity between the scaled and normalized touch trajectory and any stored touch trajectory is greater than a preset threshold; and
when the similarity is greater than the preset threshold, determining that the match between the obtained touch trajectory and the stored touch trajectory is successful.

18. The non-transitory computer-readable medium according to claim 16, wherein the application programs or the application program functions are those application programs or application program functions that can be triggered by a touch trajectory.

19. The non-transitory computer-readable medium according to claim 18, wherein:
the application programs include a painting program; and
the obtained touch trajectories includes one or more of a single finger click trajectory, a two finger click trajectory, a three finger click trajectory, a single finger straight line slide trajectory, a two finger straight line slide trajectory, and a three finger straight line slide trajectory.

20. The non-transitory computer-readable medium according to claim 19, wherein the mapping relationships in the mapping index table include:
the single finger click trajectory is mapped to a first paint effect function;
the two finger click trajectory is mapped to a second paint effect function;
the three finger click trajectory is mapped to a third paint effect function; and
the single finger straight line slide trajectory is mapped to a function canceling a previous coloring function.
